(19) United States
(12) Patent Application Publication
(10) Pub. No.: US 2014/0292608 A1
(43) Pub. Date: Oct. 2, 2014

(54) ANTENNA APPARATUS CAPABLE OF REDUCING DECREASE IN GAIN DUE TO ADJACENT METAL COMPONENTS

(71) Applicant: PANASONIC CORPORATION, Osaka (JP)

(72) Inventor: Taichi HAMABE, Osaka (JP)

(21) Appl. No.: 14/305,319

(22) Filed: Jun. 16, 2014

Related U.S. Application Data
(63) Continuation of application No. PCT/JP2013/007488, filed on Dec. 19, 2013.

(30) Foreign Application Priority Data
Jan. 28, 2013 (JP) 2013-012836

(51) Int. Cl. H01Q 1/48

(52) U.S. Cl. CPC H01Q 1/48
USPC 343/848

(57) ABSTRACT

An antenna apparatus is provided close to an external metal component. The antenna apparatus is provided with an antenna and a ground conductor plate. The ground conductor plate is provided on as to be close to the metal component to be electromagnetically coupled to the metal component, and so as to oppose the metal component. The ground conductor plate has at least one opening.

### CROSS-REFERENCE TO RELATED APPLICATIONS

This is a continuation application of International Application No. PCT/JP2013/007488, with an international filing date of Dec. 19, 2013, which claims priority of Japanese Patent Application No. 2013-012836 filed on Jan. 28, 2013, the content of which is incorporated herein by reference.

### BACKGROUND

1. Technical Field

The present disclosure relates to an antenna apparatus, a wireless communication apparatus provided with the antenna apparatus, and an electronic apparatus provided with the wireless communication apparatus.

2.Description of Related Art

Electronic apparatuses have been widely used, each electronic apparatus being provided with a wireless communication apparatus for receiving broadcast signals of, e.g., terrestrial digital television broadcast, and a display apparatus for displaying contents of the received broadcast signals. Various shapes and arrangements for antenna apparatuses of the wireless communication apparatuses are proposed (e.g., see Japanese Patent laid-open Publication No. 2007-281906 A).

### SUMMARY

In the case that an electronic apparatus provided with a wireless communication apparatus is configured as a mobile apparatus, an antenna apparatus may be close to other metal components in the electronic apparatus, because of a limited size of a housing of the electronic apparatus. In this case, the gain of the antenna apparatus may decrease, since a current having a phase opposite to that of a current flowing in the antenna apparatus may flow in the metal components.

Further, in order to improve reception sensitivity, for example, an adaptive control may be performed, such as the combined diversity scheme, in which a plurality of antennas are provided inside or outside a housing of an electronic apparatus, and received signals received with the plurality of antennas are combined in phase. In this case, the problem of the decrease in the gain of the antenna apparatus may become more significant than that in the case of using one antenna.

One non-limiting and exemplary embodiment presents an antenna apparatus effective to reduce the decrease in the gain. In addition, the present disclosure presents a wireless communication apparatus provided with the antenna apparatus, and an electronic apparatus provided with the wireless communication apparatus.

According to a general aspect of an antenna apparatus of the present disclosure, an antenna apparatus is provided close to an external metal component. The antenna apparatus is provided with at least one antenna and a ground conductor plate. The ground conductor plate is provided so as to be close to the metal component to be electromagnetically coupled to the metal component, and so as to oppose the metal component. The ground conductor plate has at least one opening.

Additional benefits and advantages of the disclosed embodiments will be apparent from the specification and Figures. The benefits and/or advantages may be individually provided by the various embodiments and features of the specification and drawings disclosure, and need not all be provided in order to obtain one or more of the same.

The antenna apparatus, the wireless communication apparatus, and the electronic apparatus of the present disclosure are effective to reduce the decrease in the gain of the antenna apparatus.

### BRIEF DESCRIPTION OF DRAWINGS

FIG. 1 is a perspective view showing an electronic apparatus 100 according to an embodiment.

FIG. 2 is an exploded perspective view of the electronic apparatus 100 of FIG. 1.

FIG. 3 is a cross-sectional view of the electronic apparatus 100 at an A-A line of FIG. 1.

FIG. 4 is a plan view of an antenna apparatus 107 of FIG. 2, seen from a front side thereof.

FIG. 5 is a plan view of the antenna apparatus 107 of FIG. 2, seen from a back side thereof.

FIG. 6 is a perspective view showing currents flowing in an antenna apparatus 107A of a comparison example, and flowing in a liquid crystal display 102.

FIG. 7 is a perspective view showing currents flowing in the antenna apparatus 107 of FIG. 2, and flowing in the liquid crystal display 102.

FIG. 8 is a perspective view showing currents flowing in an antenna apparatus 107B according to a modified embodiment, and flowing in the liquid crystal display 102.

FIG. 9 is a radiation pattern diagram of a vertically-polarized radio wave of an antenna 1 of FIG. 2.

FIG. 10 is a radiation pattern diagram of a vertically-polarized radio wave of an antenna 2 of FIG. 2.

FIG. 11 is a radiation pattern diagram of a vertically-polarized radio wave of an antenna 3 of FIG. 2.

FIG. 12 is a radiation pattern diagram of a vertically-polarized radio wave of an antenna 4 of FIG. 2.

FIG. 13 is a radiation pattern diagram of a horizontally-polarized radio wave of the antenna 1 of FIG. 2.

FIG. 14 is a radiation pattern diagram of a horizontally-polarized radio wave of the antenna 2 of FIG. 2.

FIG. 15 is a radiation pattern diagram of a horizontally-polarized radio wave of the antenna 3 of FIG. 2.

FIG. 16 is a radiation pattern diagram of a horizontally-polarized radio wave of the antenna 4 of FIG. 2.

FIG. 17 is a graph showing average gain versus frequency characteristics for the antenna 1 of FIG. 2 and the antenna 1 of FIG. 6.

### DETAILED DESCRIPTION

Embodiment are described in detail below with appropriate reference to the drawings. It is noted that excessively detailed explanation may be omitted. For example, detailed explanation on the already well-known matter, and repeated explanation on substantially the same configuration may be omitted.

It is intended to avoid excessive redundancy of the following explanation and facilitate understanding of those skilled in the art.

The applicant provides accompanying drawings and the following explanation in order for those skilled in the art to fully understand the present disclosure, and does not intend to limit claimed subject matters by the drawings and explanation.

### 1. Embodiment

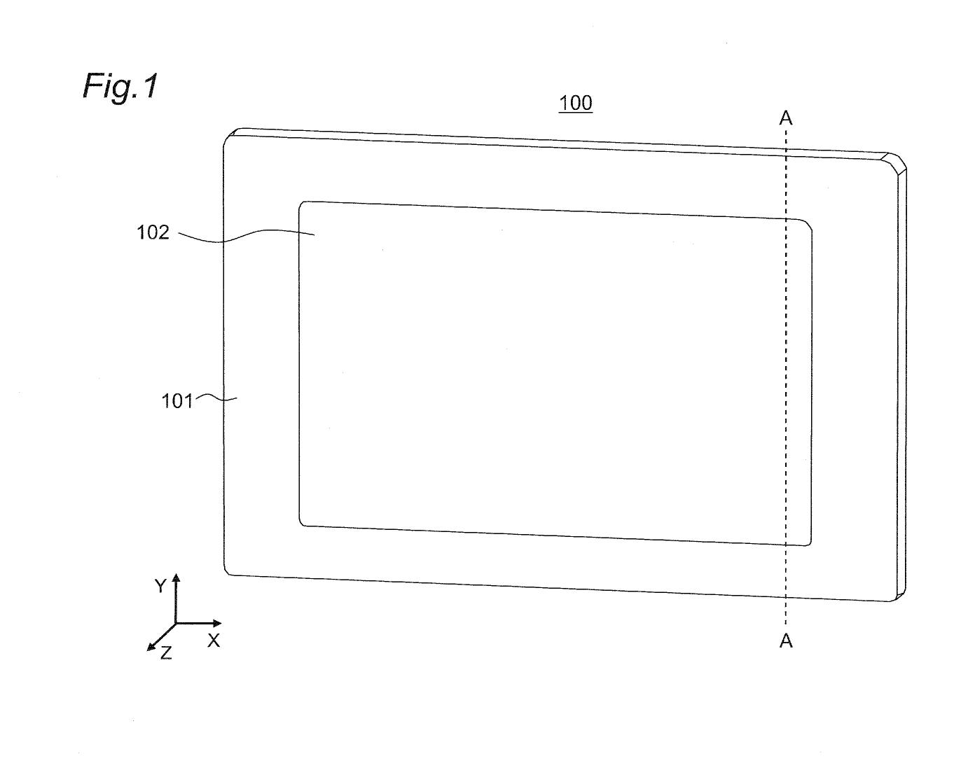

Hereinafter, embodiments of the present disclosure are described with reference to FIGS. 1 to 17.

[1-1. Configuration]

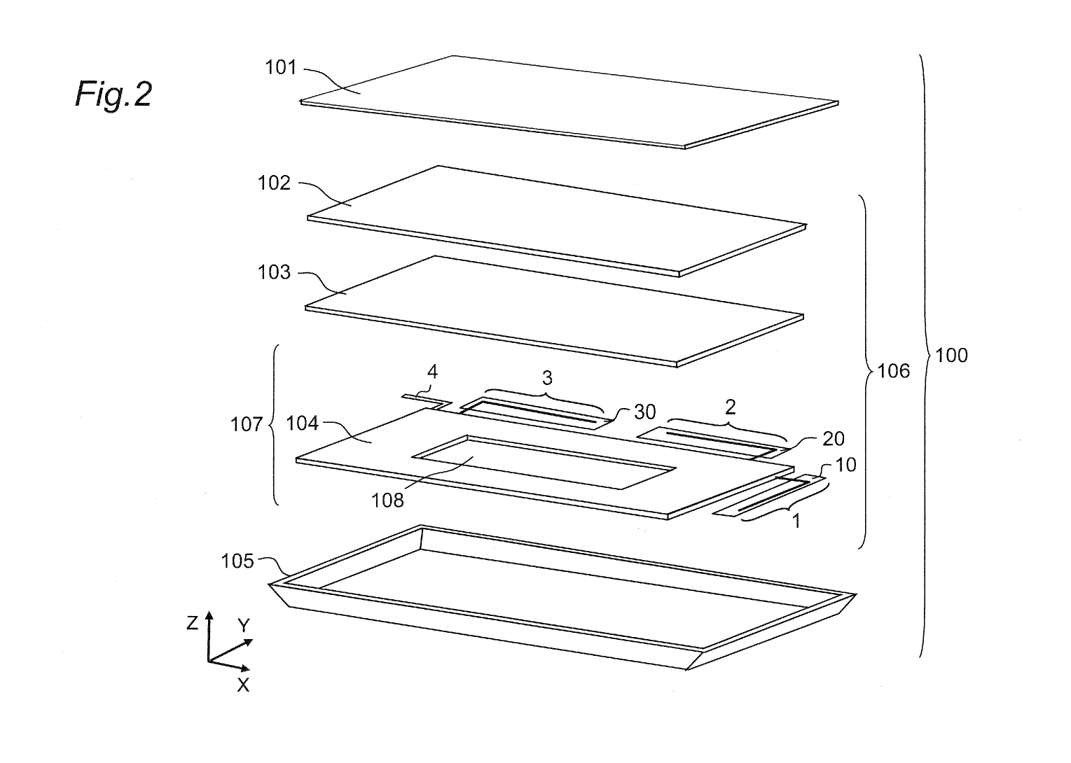

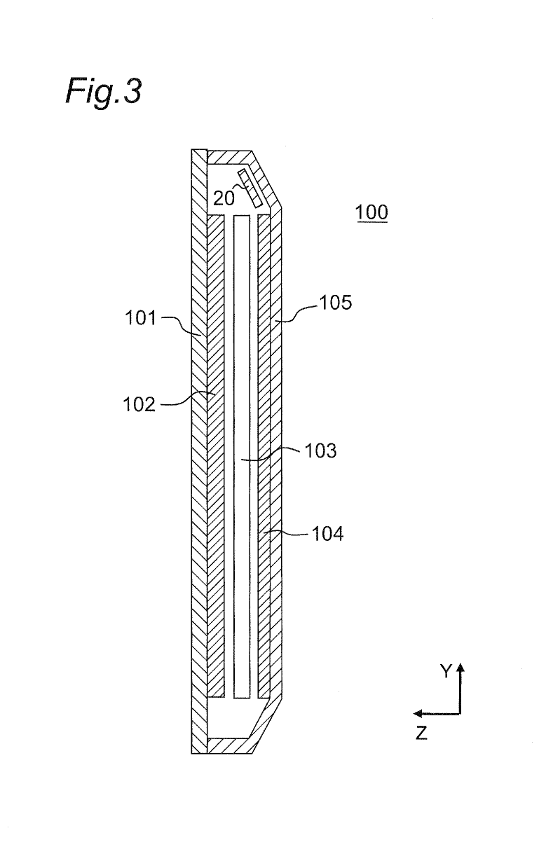

FIG. 1 is a perspective view showing an electronic apparatus 100 according to an embodiment. FIG. 2 is an exploded perspective view of the electronic apparatus 100 of FIG. 1. FIG. 3 is a cross-sectional view of the electronic apparatus 100 at an A-A line of FIG. 1. In the drawings, the XYZ coordinate shown in each drawing is referred to. With respect to FIG. 1, etc., the +Z side of the electronic apparatus 100 is called as “front”, and the −Z side of the electronic apparatus 100 is called as “back”. In addition, λ denotes an operating wavelength corresponding to an operating frequency “f′ within an operating band of the electronic apparatus 100.

As shown in FIGS. 1 to 3, the electronic apparatus 100 is configured by installing a television receiving apparatus 106 within an outer housing, the outer housing including a front panel 101 and a back cover 105. The television receiving apparatus 106 includes a liquid crystal display (LCD) 102, a main circuit board 103, and an antenna apparatus 107. The antenna apparatus 107 is provided with: antennas 1 to 4 formed on dielectric substrates 10, 20, and 30, respectively; and a ground conductor plate 104. The ground conductor plate 104 is, e.g., a planar conductor component of the electronic apparatus 100. The ground conductor plate 104 has a size equivalent to, e.g., that of the liquid crystal display 102, and for example, has a rectangular shape with a length in X direction of λ/2, and a length in Y direction of λ/4. The ground conductor plate 104 is arranged, e.g., in a position close to and parallel to the liquid crystal display 102.

The back cover 105 may be configured by chamfering edges of +X, −X, +Y, and −Y sides on the back (see FIGS. 2 and 3). In this case, the dielectric substrates 10, 20, and 30 may be located at the chamfered portions of the back cover 105. As shown in FIG. 2, for example, the dielectric substrate 10 may be located at the chamfered portion of +X side of the back cover 105, and the dielectric substrates 20 and 30 may be located at the chamfered portion of +Y side of the back cover 105.

The electronic apparatus 100 of FIG. 1 is, e.g., a mobile apparatus for receiving broadcast signals of the frequency band of the terrestrial digital television broadcast (473 MHz to 767 MHz), and displaying their contents.

The main circuit board 103 includes a circuit for controlling operation of the entire electronic apparatus 100. In particular, the main circuit board 103 is, e.g., a printed circuit board, and provided with: a power supply circuit for supplying a power supply voltage to respective circuits on the main circuit board 103; a wireless receiving circuit (tuner); and an LCD driving circuit. The wireless receiving circuit is connected to antennas 1 to 4, respectively. The wireless receiving circuit processes four received signals received by the antennas 1 to 4, using the polarization diversity (i.e., weights the respective received signals according to the signal-to-noise ratio), and combines the four received signals to one received signal. The wireless receiving circuit outputs video signals and audio signals contained in the combined received signal. In addition, the LCD driving circuit performs certain image processing on the video signals from the wireless receiving circuit, and drives the liquid crystal display 102 to display an image. Further, the electronic apparatus 100 is provided with components, such as, voice processing circuit for performing certain processing on the audio signals from the wireless receiving circuit, a speaker for outputting the processed audio signals, a recorder apparatus and a player apparatus for the video signals and the audio signals, and a metal member for radiation to reduce heat generated from components, such as the main circuit board 103 (not shown).

The antenna apparatus 107 provided with the antennas 1 to 4, and the wireless receiving circuit on the main circuit board 103 make up a wireless communication apparatus which receives the radio signals.

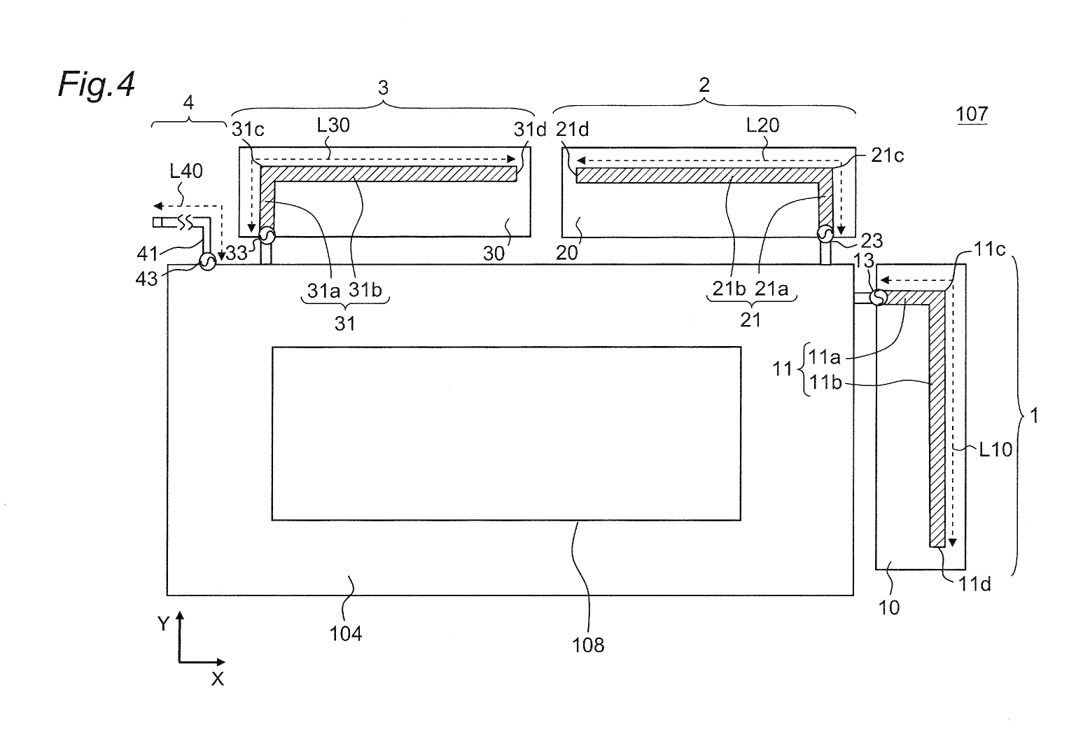

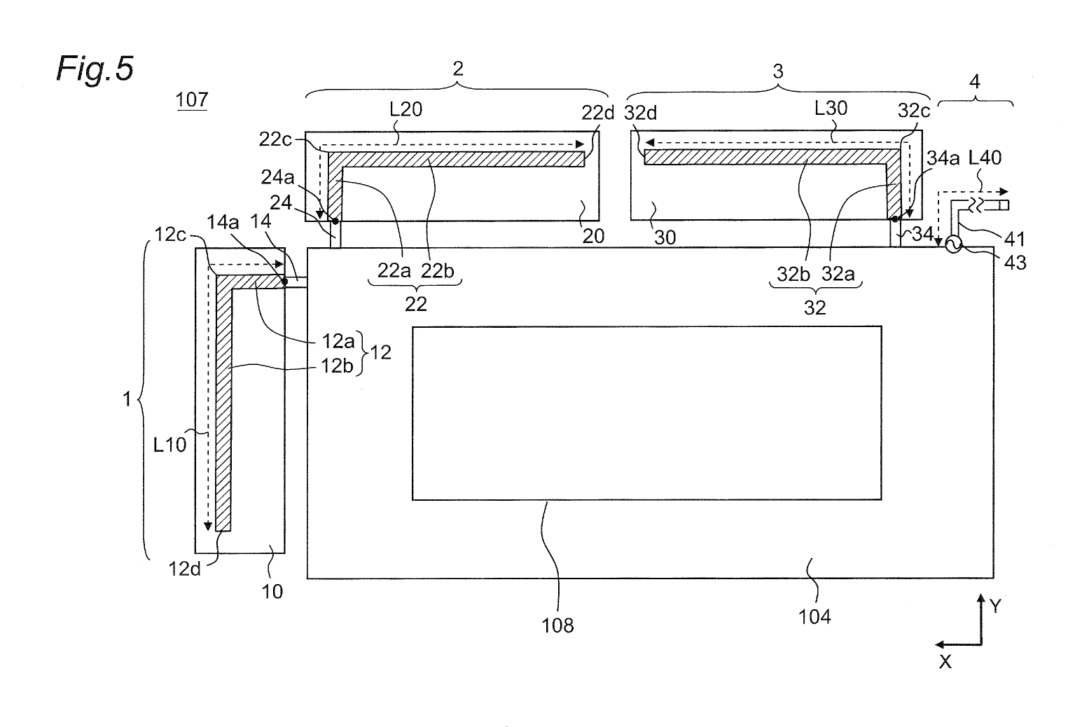

FIG. 4 is a plan view of the antenna apparatus 107 of FIG. 2, seen from a front side thereof. FIG. 5 is a plan view of the antenna apparatus 107 of FIG. 2, seen from a back side thereof. The front side of the antenna apparatus 107 opposes the main circuit board 103, and the back side of the antenna apparatus 107 opposes the back cover 105.

The liquid crystal display 102 includes a metal component, e.g., extending over the entire back side of the liquid crystal display 102. The ground conductor plate 104 is provided so as to be close to the metal component of the liquid crystal display 102 to be electromagnetically coupled to the metal component, over the entire surface of the ground conductor plate 104, and so as to oppose the metal component. Since the antenna apparatus 107 (in particular, the ground conductor plate 104) is close to the metal component of the liquid crystal display 102, a current having a phase opposite to that of a current flowing in the ground conductor plate 104 may flow in the metal component, and thus, the gain of the antenna apparatus may decrease. In order to reduce the decrease in the gain, the ground conductor plate 104 has at least one opening 108 inside the ground conductor plate 104. Therefore, the ground conductor plate 104 is shaped as a closed loop. The circumference of the opening 108 has a length equal to, e.g., the operating wavelength λ of the antenna apparatus 107. The metal component of the liquid crystal display 102 is a conductor plate having an outer circumference having a predetermined shape. The ground conductor plate 104 has an outer circumference having substantially the same shape and substantially the same size as the shape and size of the outer circumference of the metal component, respectively.

Now, the antenna 1 is explained.

The antenna 1 is provided with: a dielectric substrate 10, a feed element 11 having a strip shape and formed on the front side of the dielectric substrate 10 (FIG. 4), and a parasitic element 12 having a strip shape and formed on the back side of the dielectric substrate 10 (FIG. 5). The feed element 11 and the parasitic element 12 are made of conductive foil, such as copper or silver. The dielectric substrate 10, the feed element 11, and the parasitic element 12 are configured as, e.g., a printed-circuit board having conductor layers on both sides.

As shown in FIGS. 4 and 5, the feed element 11 and the parasitic element 12 may be formed as, e.g., an inverted-L type. Referring to FIG. 4, the feed element 11 includes element parts 11a and 11b, which are connected to each other at a connecting point 11c. The element part 11a extends substantially toward the +X direction from a position close to the ground conductor plate 104. The element part 11a is connected to a feeding point 13 at one end of the element part 11a, and connected to the element part 11b at the connecting point 11c of the other end of the element part 11a. The element part 11b extends substantially toward the −Y direction from the connecting point 11c.

The element part 11b is opened at an open end 11d of one end of the element part 11b, and connected to the element part 11a at the connecting point 11c of the other end of the element part 11b. Referring to FIG. 5, the parasitic element 12 includes element parts 12a and 12b, which are connected to each other at a connecting point 12c. The element part 12a extends substantially toward the +X direction from a position close to the ground conductor plate 104. The element part 12a is connected to a connecting conductor 14 at a connecting point 14a of one end of the element part 12a, and grounded to an edge of the ground conductor plate 104 through the connecting conductor 14. The element part 12a is connected to the element part 12b at the connecting point 12c of the other end of the element part 12a. The element part 12b extends substantially toward the −Y direction from the connecting point 12c. The element part 12b is opened at an open end 12d of one end of the element part 12b, and connected to the element part 12a at the connecting point 12c of the other end of the element part 12b.

As described above, the feed element 11 has the end connected to the feeding point 13 (first end), and the open end 11d (second end). The parasitic element 12 has the end connected to the ground conductor plate 104 (first end), and the open end 12d (second end). The feed element 11 and the parasitic element 12 are arranged to oppose each other, at at least a portion including the open end 11d of the feed element 11 and the open end 12d of the parasitic element 12.

The feed element 11 and the parasitic element 12 may be arranged to be capacitively coupled to each other, at at least a portion including the open end 11d of the feed element 11 and the open end 12d of the parasitic element 12. In this case, since the open end 11d of the feed element 11 and the open end 12d of the parasitic element 12 are capacitively coupled to each other, the antenna 1 operates as a folded antenna including the feed element 11 and the parasitic element 12, and folded at the open ends 11d and 12d. The electric length L10 of each of the feed element 11 and the parasitic element 12 capacitively coupled to each other is set to λ/4, and therefore, the electric length of the folded antenna is set to λ/2, and the folded antenna resonates at the frequency f. Thus, the feed element 11 and the parasitic element 12 resonate at the frequency f corresponding to the wavelength λ determined by the sum of the electric length L10 of the feed element 11 and the electric length L10 of the parasitic element 12.

The feed element 11 and the parasitic element 12 may be arranged to overlap to each other, at at least a portion including the open end 11d of the feed element 11 and the open end 12d of the parasitic element 12.

Now, the antenna 2 is explained.

The antenna 2 is provided with: a dielectric substrate 20, a feed element 21 having a strip shape and formed on the front side of the dielectric substrate 20 (FIG. 4), and a parasitic element 22 having a strip shape and formed on the back side of the dielectric substrate 20 (FIG. 5). The feed element 21 and the parasitic element 22 are made of conductive foil, such as copper or silver. The dielectric substrate 20, the feed element 21, and the parasitic element 22 are configured as, e.g., a printed-circuit board having conductor layers on both sides.

As shown in FIGS. 4 and 5, the feed element 21 and the parasitic element 22 may be formed as, e.g., an inverted-L type. Referring to FIG. 4, the feed element 21 includes element parts 21a and 21b, which are connected to each other at a connecting point 21c. The element part 21a extends substantially toward the +Y direction from a position close to the ground conductor plate 104. The element part 21a is connected to a feeding point 23 at one end of the element part 21a, and connected to the element part 21b at the connecting point 21c of the other end of the element part 21a. The element part 21b extends substantially toward the −X direction from the connecting point 21c. The element part 21b is opened at an open end 21d of one end of the element part 21b, and connected to the element part 21a at the connecting point 21c of the other end of the element part 21b. Referring to FIG. 5, the parasitic element 22 includes element parts 22a and 22b, which are connected to each other at a connecting point 22c. The element part 22a extends substantially toward the +Y direction from a position close to the ground conductor plate 104. The element part 12a is connected to a connecting conductor 24 at a connecting point 24a of one end of the element part 22a, and grounded to an edge of the ground conductor plate 104 through the connecting conductor 24. The element part 22a is connected to the element part 22b at the connecting point 22c of the other end of the element part 22a. The element part 22b extends substantially toward the −X direction from the connecting point 22c. The element part 22b is opened at an open end 22d of one end of the element part 22b, and connected to the element part 22a at the connecting point 22c of the other end of the element part 22b.

As described above, the feed element 21 has the end connected to the feeding point 23 (first end), and the open end 21d (second end). The parasitic element 22 has the end connected to the ground conductor plate 104 (first end), and the open end 22d (second end). The feed element 21 and the parasitic element 22 are arranged to oppose each other, at at least a portion including the open end 21d of the feed element 21 and the open end 22d of the parasitic element 22.

The feed element 21 and the parasitic element 22 may be arranged to be capacitively coupled to each other, at at least a portion including the open end 21d of the feed element 21 and the open end 22d of the parasitic element 22. In this case, since the open end 21d of the feed element 21 and the open end 22d of the parasitic element 22 are capacitively coupled to each other, the antenna 2 operates as a folded antenna including the feed element 21 and the parasitic element 22, and folded at the open ends 21d and 22d. The electric length L20 of each of the feed element 21 and the parasitic element 22 capacitively coupled to each other is set to λ/4, and therefore, the electric length of the folded antenna is set to λ/2, and the folded antenna resonates at the frequency f. Thus, the feed element 21 and the parasitic element 22 resonate at the frequency f corresponding to the wavelength λ determined by the sum of the electric length L20 of the feed element 21 and the electric length L20 of the parasitic element 22.

The feed element 21 and the parasitic element 22 may be arranged to overlap to each other, at at least a portion including the open end 21d of the feed element 21 and the open end 22d of the parasitic element 22.

Now, the antenna 3 is explained.

The antenna 3 is provided with: a dielectric substrate 30, a feed element 31 having a strip shape and formed on the front side of the dielectric substrate 30 (FIG. 4), and a parasitic element 32 having a strip shape and formed on the back side of the dielectric substrate 30 (FIG. 5). The feed element 31 and the parasitic element 32 are made of conductive foil, such as copper or silver. The dielectric substrate 30, the feed element 31, and the parasitic element 32 are configured as, e.g., a printed-circuit board having conductor layers on both sides.

As shown in FIGS. 4 and 5, the feed element 31 and the parasitic element 32 may be formed as, e.g., an inverted-L type. Referring to FIG. 4, the feed element 31 includes element parts 31a and 31b, which are connected to each other at a connecting point 31c. The element part 31a extends substantially toward the +Y direction from a position close to the ground conductor plate 104. The element part 31a is connected to a feeding point 33 at one end of the element part 31a, and connected to the element part 31b at the connecting point 31c of the other end of the element part 31a. The element part 31b extends substantially toward the +X direction from the connecting point 31c. The element part 31b is opened at an open end 31d of one end of the element part 31b, and connected to the element part 31a at the connecting point 31c of the other end of the element part 31b. Referring to FIG. 5, the parasitic element 32 includes element parts 32a and 32b, which are connected to each other at a connecting point 32c. The element part 32a extends substantially toward the +Y direction from a position close to the ground conductor plate 104. The element part 32a is connected to a connecting conductor 34 at a connecting point 34a of one end of the element part 32a, and grounded to an edge of the ground conductor plate 104 through the connecting conductor 34. The element part 32a is connected to the element part 32b at the connecting point 32c of the other end of the element part 32a. The element part 32b extends substantially toward the +X direction from the connecting point 32c. The element part 32b is opened at an open end 32d of one end of the element part 32b, and connected to the element part 32a at the connecting point 32c of the other end of the element part 32b.

As described above, the feed element 31 has the end connected to the feeding point 33 (first end), and the open end 31d (second end). The parasitic element 32 has the end connected to the ground conductor plate 104 (first end), and the open end 32d (second end). The feed element 31 and the parasitic element 32 are arranged to oppose each other, at at least a portion including the open end 31d of the feed element 31 and the open end 32d of the parasitic element 32.

The feed element 31 and the parasitic element 32 may be arranged to be capacitively coupled to each other, at at least a portion including the open end 31d of the feed element 31 and the open end 32d of the parasitic element 32. In this case, since the open end 31d of the feed element 31 and the open end 32d of the parasitic element 32 are capacitively coupled to each other, the antenna 3 operates as a folded antenna including the feed element 31 and the parasitic element 32, and folded at the open ends 31d and 32d. The electric length L30 of each of the feed element 31 and the parasitic element 32 capacitively coupled to each other is set to λ/4, and therefore, the electric length of the folded antenna is set to λ/2, and the folded antenna resonates at the frequency f. Thus, the feed element 31 and the parasitic element 32 resonate at the frequency f corresponding to the wavelength λ determined by the sum of the electric length L30 of the feed element 31 and the electric length L30 of the parasitic element 32.

The feed element 31 and the parasitic element 32 may be arranged to overlap to each other, at at least a portion including the open end 31d of the feed element 31 and the open end 32d of the parasitic element 32.

Now, the antenna 4 is explained.

Referring to FIGS. 4 and 5, the antenna 4 is a monopole antenna provided with a feed element 41 having a strip shape, and the antenna 4 is connected to a feeding point 43. The feed element 41 may be projected from the housing of the electronic apparatus 100 in the −X direction or any other direction. The electric length L40 of the feed element 41 is set to λ/4, and the antenna 4 resonates at the frequency f.

As described above, the antenna apparatus 107 is provided with the feeding points 13, 23, 33, and 43, and the antennas 1 to 4 connected to the respective feeding points. The antennas 1 to 4 are respectively connected to the wireless receiving circuit of the main circuit board 103 through feed lines each having an impedance of, e.g., 50 ohms. The wireless receiving circuit receives radio signals having the frequency f using the antennas 1 to 4.

At least one of the antennas 1 to 4 may have a different polarization direction from the other antennas. Therefore, for example, the antennas 1 to 4 are arranged as follows. The antenna 1 is provided close to an edge on the +X side of the ground conductor plate 104, and the feeding point 13 is provided close to a corner at the +X side and +Y side of the ground conductor plate 104. The antenna 2 is provided close to an edge on the +Y side of the ground conductor plate 104, and the feeding point 23 is provided close to the corner at the +X side and +Y side of the ground conductor plate 104. The antenna 3 is provided close to the edge on the +Y side of the ground conductor plate 104, and the feeding point 33 is provided close to a corner at the −X side and +Y side of the ground conductor plate 104. The antenna 4 is provided close to the corner at the −X side and the +Y side of the ground conductor plate 104, and the feeding point 43 is provided close to the corner at the −X side and the +Y side of the ground conductor plate 104. The antenna 1 receives a vertically-polarized radio wave having a polarization direction parallel to the X axis. The antenna 2 receives a vertically-polarized radio wave having a polarization direction parallel to the Y axis. The antenna 3 receives a vertically-polarized radio wave having a polarization direction parallel to the Y axis. The antenna 4 receives a horizontally-polarized radio wave.

For performing the polarization diversity processing, the antennas 1 to 4 are configured to have the same resonance frequency with each other. The antennas 1 to 3 may have different sizes from each other, in order to obtain the same resonance frequency, taking into consideration the influences from other components of the electronic apparatus 100.

[1-2. Operation]

Now, an operation of the antenna apparatus 107 configured as mentioned above is explained.

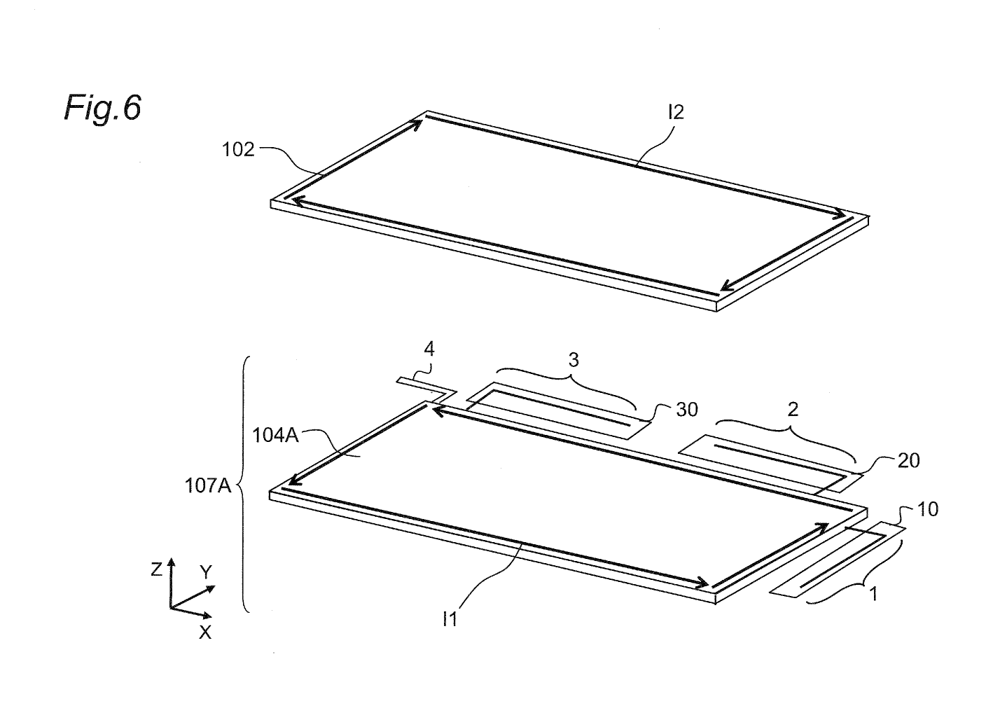

FIG. 6 is a perspective view showing currents flowing in an antenna apparatus 107A of a comparison example, and flowing in the liquid crystal display 102. The antenna apparatus 107A is provided with a ground conductor plate 104A with no opening, in place of the antenna apparatus 104 having the opening 108 of FIG. 2. For example, when a current I1 flows in the ground conductor plate 104A due to excitation of the antenna 1, a current I2 having a phase opposite to that of the current I1 flows in the metal component of the liquid crystal display 102. The currents I1 and I2 may cancel each other, and the gain of the antenna apparatus 107A may decrease.

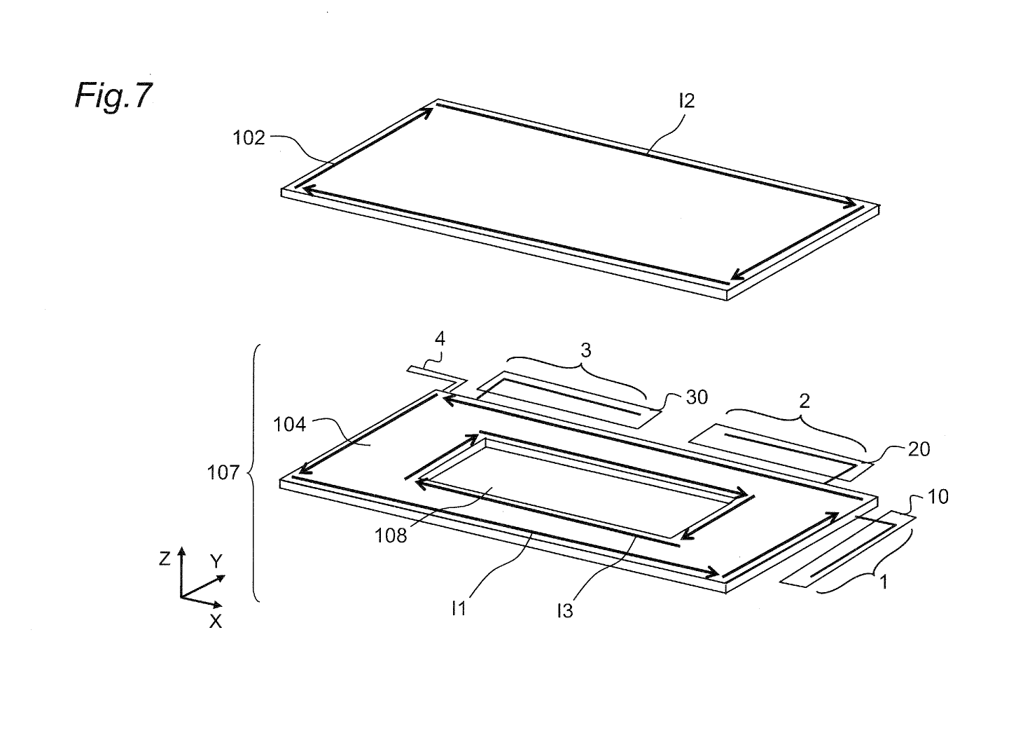

FIG. 7 is a perspective view showing currents flowing in the antenna apparatus 107 of FIG. 2, and flowing in the liquid crystal display 102. For example, when a current I1 flows in the ground conductor plate 104 due to excitation of the antenna 1, a current I2 having a phase opposite to that of the current I1 flows in the metal component of the liquid crystal display 102, in a manner similar to that of the antenna apparatus 107A of FIG. 6. In this case, a current I3 having a phase opposite to that of the current I1 further flows in the periphery of the opening 108 on the ground conductor plate 104. Even if the currents I1 and I2 cancel each other, the current I3 contributes to radiation of the antenna apparatus 107, and therefore, it is possible to reduce the decrease in the gain of the antenna apparatus 107.

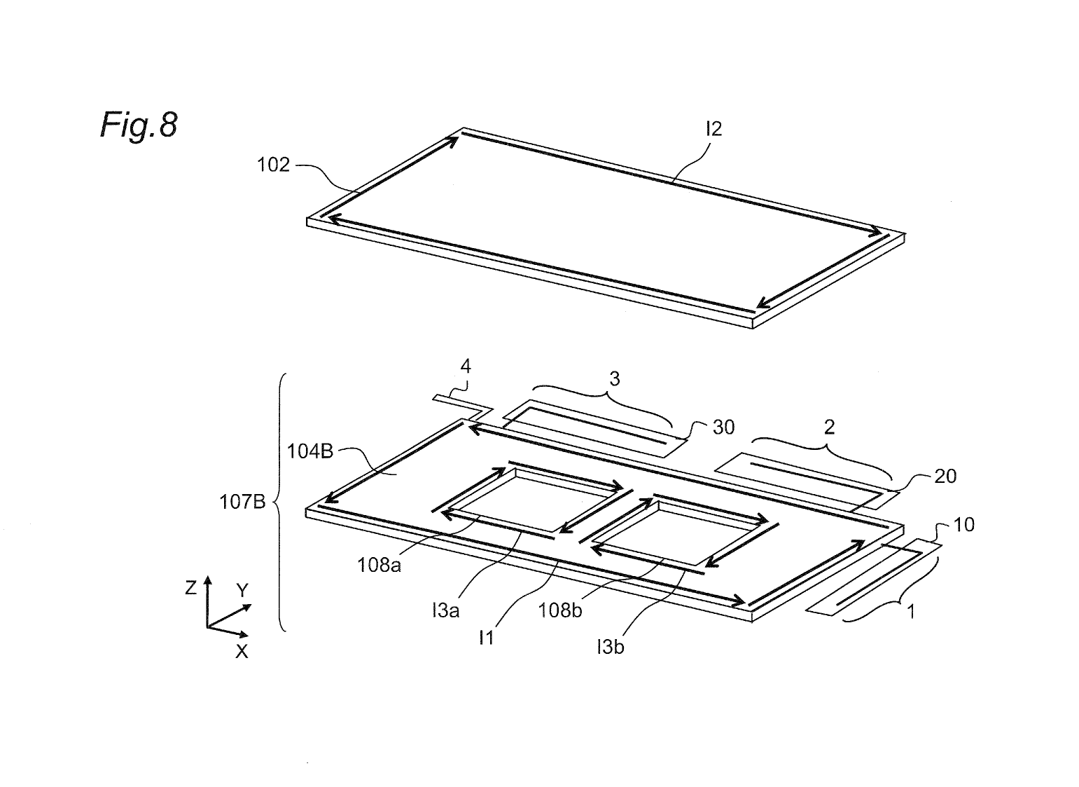

FIG. 8 is a perspective view showing currents flowing in an antenna apparatus 107B according to a modified embodiment, and flowing in the liquid crystal display 102. A ground conductor plate of an antenna apparatus may have a plurality of openings. The antenna apparatus 107B of FIG. 8 is provided with a ground conductor plate 104B having two openings 108a and 108b. For example, when a current I1 flows in the ground conductor plate 104B due to excitation of the antenna 1, a current I2 having a phase opposite to that of the current I1 flows in the metal component of the liquid crystal display 102, in a manner similar to that of the antenna apparatus 107A of FIG. 6. In this case, currents I3a and I3b each having a phase opposite to that of the current I1 further flow in the peripheries of the openings 108a and 108b on the ground conductor plate 104B, respectively. Even if the currents I1 and I2 cancel each other, the currents I3a and I3b contribute to radiation of the antenna apparatus 107B, and therefore, it is possible to reduce the decrease in the gain of the antenna apparatus 107B.

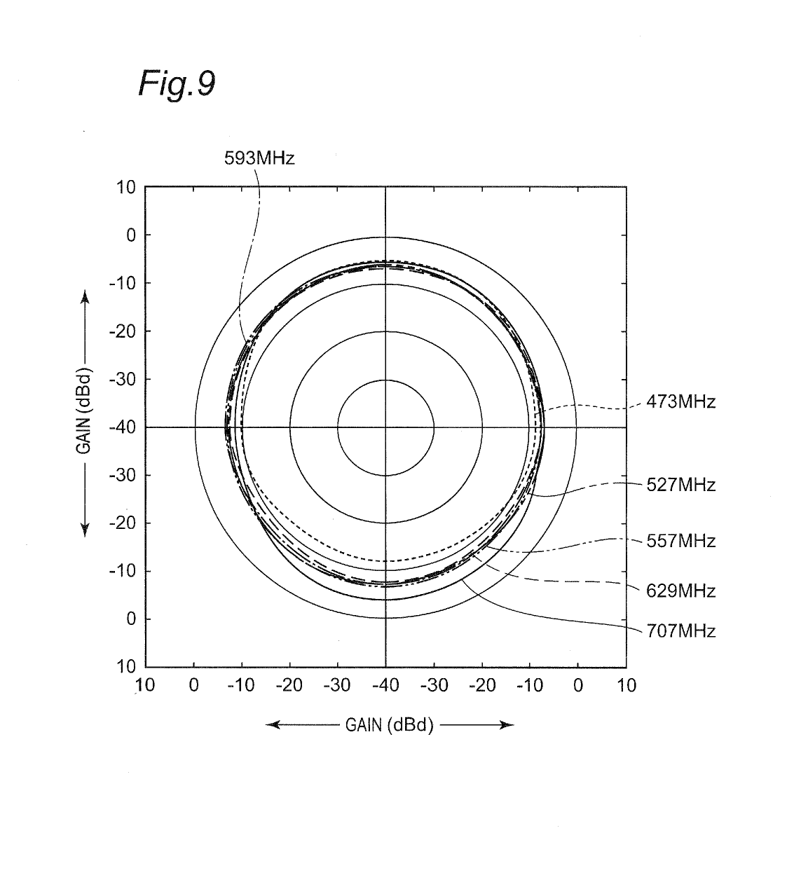

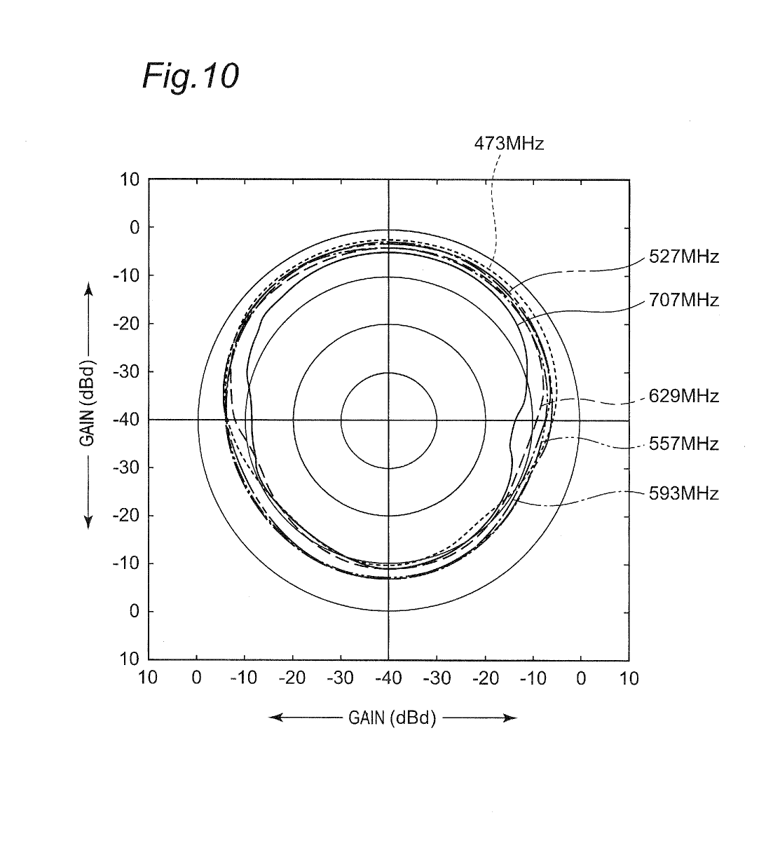

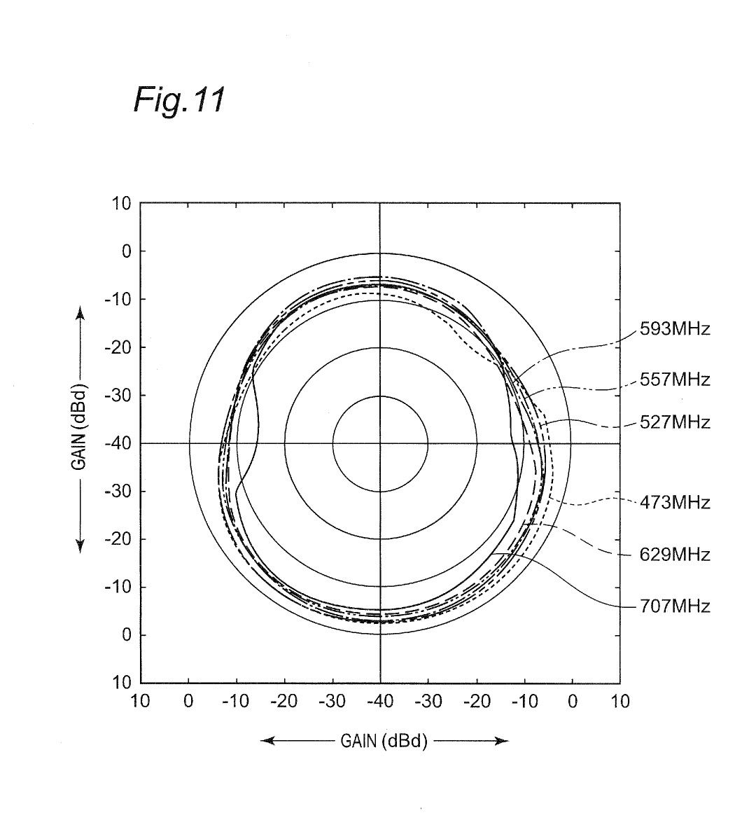

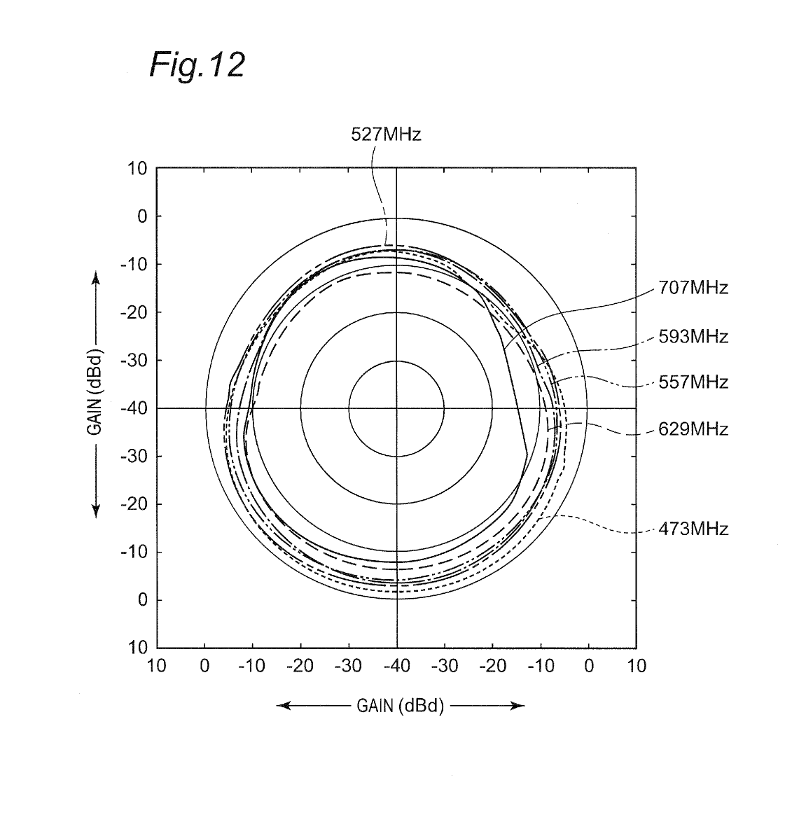

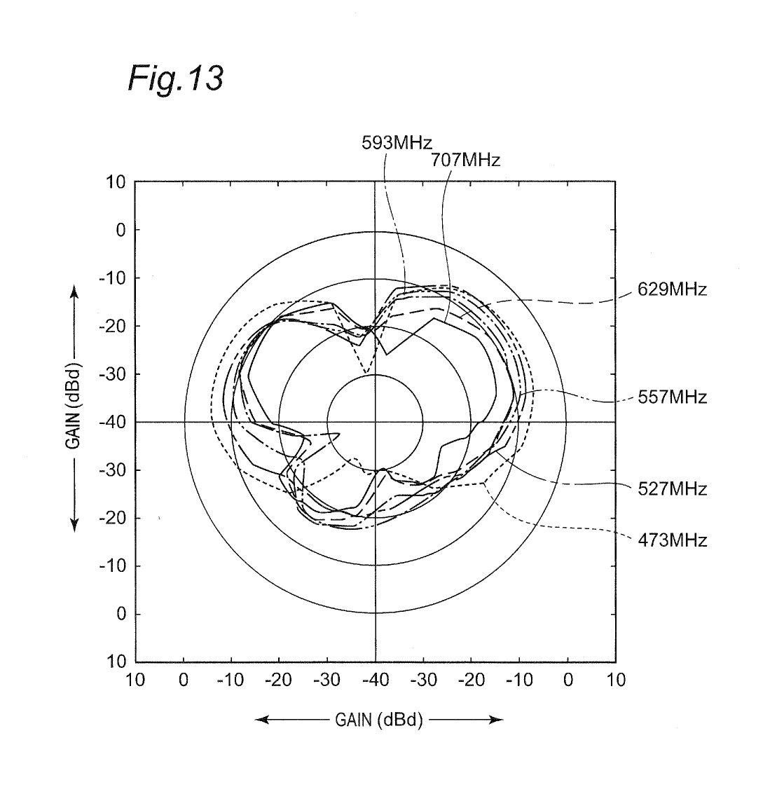

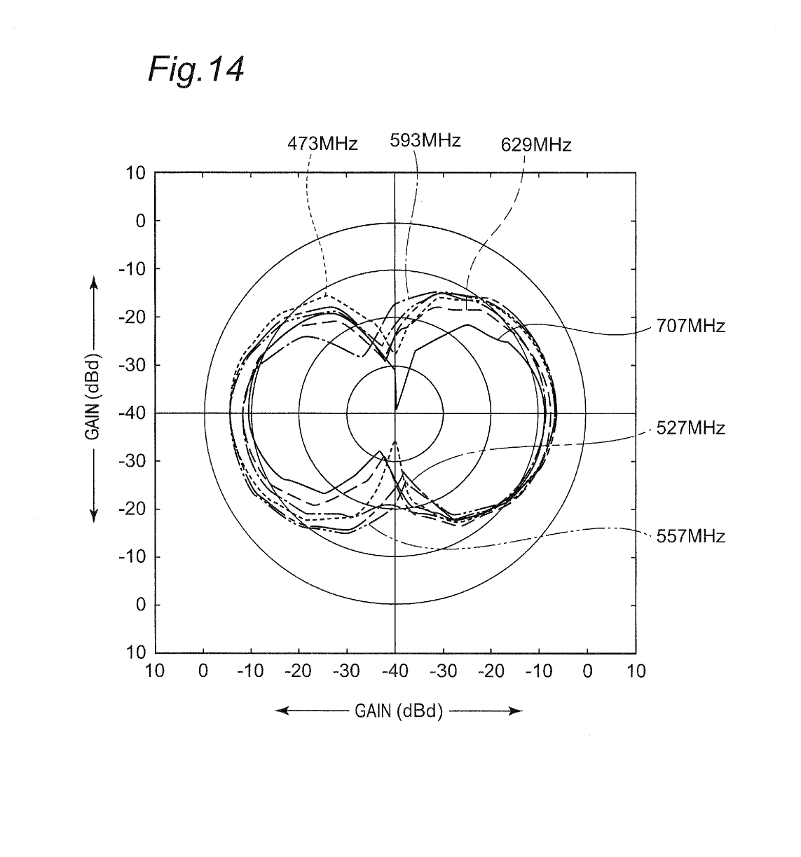

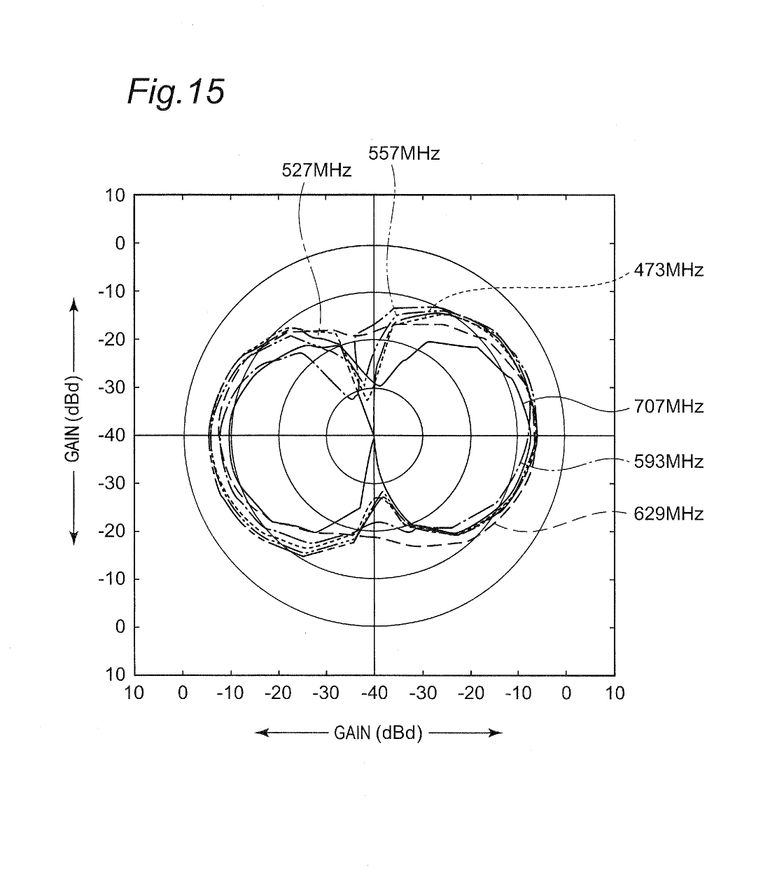

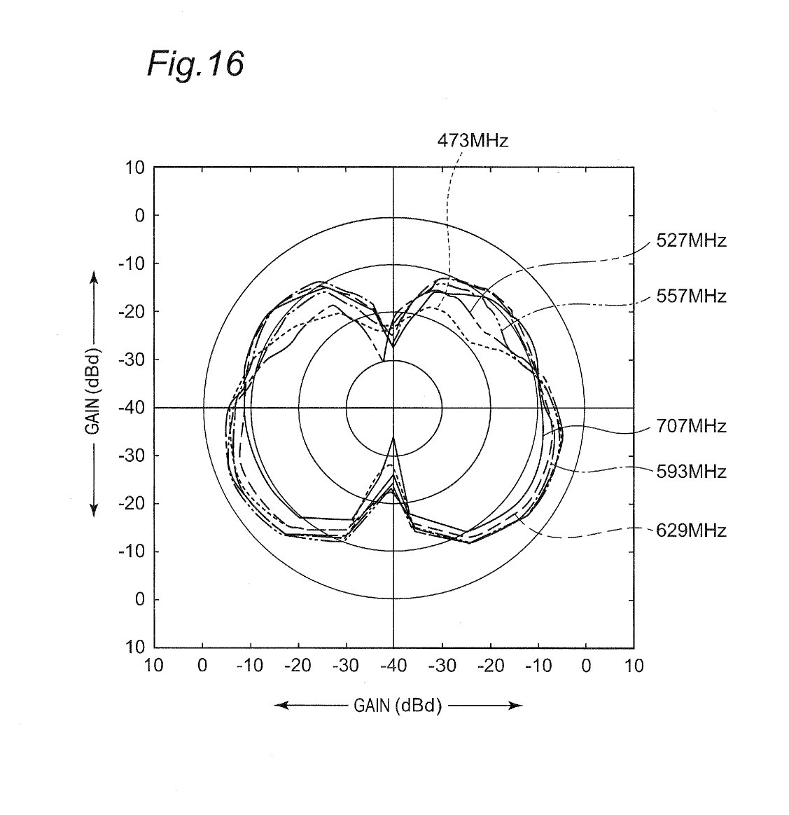

FIG. 9 is a radiation pattern diagram of a vertically-polarized radio wave of the antenna 1 of FIG. 2. FIG. 10 is a radiation pattern diagram of a vertically-polarized radio wave of the antenna 2 of FIG. 2. FIG. 11 is a radiation pattern diagram of a vertically-polarized radio wave of the antenna 3 of FIG. 2. FIG. 12 is a radiation pattern diagram of a vertically-polarized radio wave of the antenna 4 of FIG. 2. FIG. 13 is a radiation pattern diagram of a horizontally-polarized radio wave of the antenna 1 of FIG. 2. FIG. 14 is a radiation pattern diagram of a horizontally-polarized radio wave of the antenna 2 of FIG. 2. FIG. 15 is a radiation pattern diagram of a horizontally-polarized radio wave of the antenna 3 of FIG. 2. FIG. 16 is a radiation pattern diagram of a horizontally-polarized radio wave of the antenna 4 of FIG. 2. As shown in FIGS. 9 to 12, the antennas 1 to 4 are substantially omnidirectional for vertically-polarized radio waves over the entire frequency band of the terrestrial digital television broadcast.

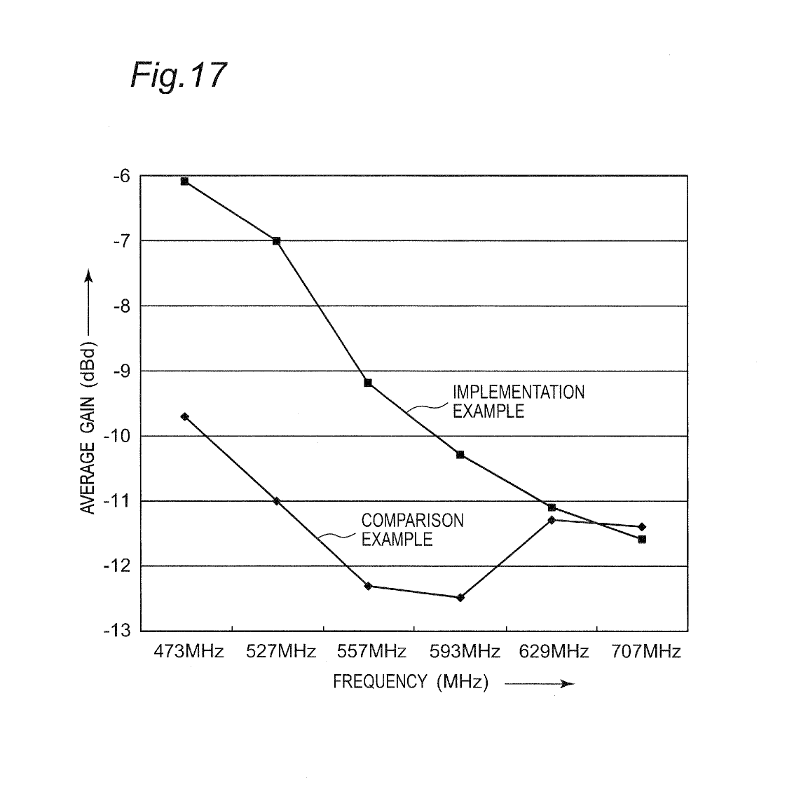

FIG. 17 is a graph showing average gain versus frequency characteristics for the antenna 1 of FIG. 2 and the antenna 1 of FIG. 6. The vertical axis of the graph shows an average gain under a cross polarization of −6 dB (”a gain of horizontal polarization” +(“a gain of vertical polarization” −6)). Referring to FIG. 17, “implementation example” indicates an average gain for the antenna 1 of FIG. 2, and “comparison example” indicates an average gain for the antenna 1 of FIG. 6. As shown in FIG. 17, the gain of low frequency in the case of using the ground conductor plate 104 having the opening 108 (FIG. 2) is improved than that in the case of using the ground conductor plate 104A with no opening (FIG. 6).

[1-3. Advantageous Effects, Etc.]

As described above, the antenna apparatus 107 of the embodiment is provided with: the at least one antenna 1 to 4 provide close to the metal component of the liquid crystal display 102; and the ground conductor plate 104. The ground conductor plate 104 is provided so as to be close to the metal component to be electromagnetically coupled to the metal component, and so as to oppose the metal component. The ground conductor plate 104 has the at least one opening 108. Therefore, the antenna apparatus 107 can operate in a wide band by using resonance of the metal component of the liquid crystal display 102.

In addition, the metal component of the liquid crystal display 102 is the conductor plate having the outer circumference having the predetermined shape. The ground conductor plate 104 has the outer circumference having substantially the same shape and substantially the same size as the shape and size of the outer circumference of the metal component. Therefore, even if the current I1 flowing in the ground conductor plate 104 cancels the current I2 flowing in the metal component, it is possible to reduce the decrease in the gain, because of the current I3 flowing in the periphery of the opening 108 on the ground conductor plate 104. The antenna apparatus 107 can reduce the decrease in the gain, particularly, in a low frequency.

In addition, the antennas 1 to 3 can achieve wide band operation by means of capacitive coupling between the feed elements and the parasitic elements, and using resonance of the ground conductor plate 104 due to the current flowing in the ground conductor plate 104. It is possible to reduce the decreases in the gain and in the bandwidth by means of the antennas 1 to 3, as the inverted-L folded antennas each using the parallel resonance between a feed element and a parasitic element.

In addition, when the antennas 1 and 2 are provided adjacent to each other as shown in FIG. 4 and FIG. 5, the antenna 1 receives a horizontally-polarized radio wave, and the antenna 2 receives a vertically-polarized radio wave. Therefore, the direction of a ground current resulting from the receiving operation of the antenna 1 is perpendicular to the direction of a ground current resulting from the receiving operation of the antenna 2. As a result, it is possible to increase the isolation between the antennas 1 and 2. Therefore, it is possible to substantially prevent the decrease in the gain occurring when a signal flows from one of the antennas 1 and 2 to another one to decrease the signal-to-noise ratios of the received signals of the antennas 1 and 2.

In addition, a distance between the feeding point 23 of the antenna 2 and the feeding point 33 of the antenna 3 is set to λ/4 or more. Therefore, when a ground current resulting from the receiving operation of the antenna 2 is flowing, no ground current resulting from the receiving operation of the antenna 3 flows. As a result, it is possible to increase the isolation between the antennas 2 and 3. Therefore, it is possible to substantially prevent the decrease in the gain occurring when a signal flows from one of the antennas 2 and 3 to another one to decrease the signal-to-noise ratios of the received signals of the antennas 2 and 3.

In addition, the antenna 3 receives a vertically-polarized radio wave, and the antenna 4 receives a horizontally-polarized radio wave. Therefore, it is possible to increase the isolation between the antennas 3 and 4, as compared with that of the case where the antennas 3 and 4 receive radio waves having the same polarization direction. Therefore, it is possible to substantially prevent the decrease in the gain occurring when a signal flows from one of the antennas 3 and 4 to another one to decrease the signal-to-noise ratios of the received signals of the antennas 3 and 4.

In addition, according to the antenna apparatus of the embodiment, it is possible to reduce the size of the electronic apparatus 100, since the antennas 1 to 4 can be provided close to the ground conductor plate 104. In addition, it is possible to provide the electronic apparatus 100 which is inexpensive and highly water-resistant, since no housing is needed other than the housing of the electronic apparatus 100 itself to install the antenna apparatus provided with the antennas 1 to 4. In addition, since the antennas 1 to 3 can be arranged at the chamfered portions of the back cover 105, it is possible to emphasize the thinness in the appearance of the electronic apparatus 100, and strengthen the structure of its housing.

### 2. Other Embodiments

As described above, the electronic apparatus 100 of the embodiment has been explained as an exemplary implementation of the present disclosure. However, the embodiment of the present disclosure is not limited thereto, and can be applied to configurations with changes, substitutions, additions, omissions, etc. in an appropriate manner. In addition, the above mentioned components can be combined to provide a new embodiment.

Hereinafter, other embodiments are explained collectively.

Although the ground conductor plate 104 of FIGS. 4 and 5 has the opening 108 at its middle, the opening may be located at a position other than the middle of the ground conductor plate 104. For example, when using the ground conductor plate 104 also as a radiating member for decreasing heat generated from circuits and components on the main circuit board 103, the opening is provided at a portion other than radiating areas of the ground conductor plate 104.

According to the described embodiment, the metal component of the liquid crystal display 102, and the ground conductor plate 104 have substantially the same shapes and substantially the same the sizes. However, at least one of the shapes and the sizes may differ. For example, even if the metal component of the liquid crystal display 102 is larger than the outer circumference of the ground conductor plate 104, it is possible to reduce the decrease in the gain of the antenna apparatus 107.

In addition, according to the described embodiment, the antenna apparatus 107 disclosed above may be provided with three antennas 1 to 3, one monopole antenna, and the ground conductor plate 104. However, an antenna apparatus may be provided with at least one antenna configured in a manner similar to that of the antenna 1 of FIGS. 4 and 5, and provided with the ground conductor plate. In addition, the monopole antenna may be omitted, or an antenna apparatus provided with two or more monopole antennas may be provided. In addition, an antenna apparatus may be provided with at least one arbitrary antenna different from the antennas 1 to 3.

In addition, the ground conductor plate 104 is not limited to be provided as a dedicated component. Other components, such as a shield plate of the electronic apparatus 100, may be used as the ground conductor plate 104 of the antenna apparatus. In addition, the ground conductor plate 104 is not limited to be rectangular, and may be arbitrarily shaped.

In addition, according to the embodiment of FIG. 1, the dielectric substrates 10, 20, and 30 are arranged at the chamfered portions of the back cover 105. However, the embodiment of the present disclosure is not restricted thereto. The dielectric substrates 10, 20, and 30 may be arranged on the same surface as that of the ground conductor plate 104, and in parallel to the ground conductor plate 104, respectively. In addition, the dielectric substrates 10, 20, and 30 may be arranged on a surface different from the ground conductor plate 104 (e.g., the same surface as a surface including the liquid crystal display 102), and in parallel to the surface, respectively.

In addition, according to the described embodiment, the electronic apparatus 100 receives the broadcast signals of the frequency band of the terrestrial digital television broadcast. However, the embodiment of the present disclosure is not restricted thereto. The main circuit board 103 may be provided with a wireless transmitting circuit for transmitting radio signals using the antenna apparatus 107, and may be provided with a wireless communication circuit for performing at least one of transmission and reception of radio signals using the antenna apparatus 107. The antenna apparatus 107 provided with the antennas 1 to 4, and the wireless receiving circuit on the main circuit board 103 make up a wireless communication apparatus which performs at least one of transmission and reception of the radio signals. In addition, according to the described embodiment, an exemplary electronic apparatus is explained, which is the mobile apparatus for receiving the broadcast signals of the frequency band of the terrestrial digital television broadcast, and displaying their contents. However, the embodiment of the present disclosure is not restricted thereto. The embodiment of the present disclosure is applicable to the antenna apparatus described above, and to the wireless communication apparatus for performing at least one of transmission and reception of radio signals using the antenna apparatus. In addition, the embodiment of the present disclosure is applicable to an electronic apparatus, such as a mobile phone, provided with: the wireless communication apparatus described above, and the display apparatus for displaying the video signals included in the radio signals received by the wireless communication apparatus.

As described above, the applicant presents the embodiment considered to be the best mode, and other embodiment, with reference to the accompanying drawings and the detailed description. These are provided to demonstrate the claimed subject matters for those skilled in the art with reference to the specific embodiment. Therefore, the components indicated to the accompanying drawings and the detailed description may include not only components essential for solving the problem, but may include other components.

Therefore, even if the accompanying drawings and the detailed description include such non-essential components, it should not be judged that the non-essential components are essential. In addition, various changes, substitutions, additions, omissions, etc. can be done to the above-described embodiment within a range of claims or their equivalency.

The present disclosure is applicable to an electronic apparatus for receiving radio signals, and displaying video signals included in the received radio signals. In particular, the present disclosure is applicable to a portable television broadcast receiving apparatus, a mobile phone, a smart phone, a personal computer, etc.

1. An antenna apparatus provided close to an external metal component,
wherein the antenna apparatus comprises at least one antenna and a ground conductor plate,
wherein the ground conductor plate is provided so as to be close to the metal component to be electromagnetically coupled to the metal component, and so as to oppose the metal component, and
wherein the ground conductor plate has at least one opening.

2. The antenna apparatus according to claim 1,
wherein the metal component is a conductor plate having an outer circumference having a predetermined shape, and
wherein the ground conductor plate has an outer circumference having substantially a same shape and substantially a same size as the shape and size of the outer circumference of the metal component, respectively.

3. The antenna apparatus according to claim 1,
wherein the antenna apparatus is provided in an electronic apparatus comprising a planar conductor component, and wherein the ground conductor plate is the planar conductor component.

4. A wireless communication apparatus comprising: an antenna apparatus provided close to an external metal component; and a wireless communication circuit configured to perform at least one of transmission and reception of radio signals using the antenna apparatus,
wherein the antenna apparatus comprises at least one antenna and a ground conductor plate,
wherein the ground conductor plate is provided so as to be close to the metal component to be electromagnetically coupled to the metal component, and so as to oppose the metal component, and
wherein the ground conductor plate has at least one opening.

5. An electronic apparatus comprising a wireless communication, the wireless communication apparatus comprising: an antenna apparatus provided close to an external metal component; and a wireless communication circuit configured to perform at least one of transmission and reception of radio signals using the antenna apparatus,
wherein the antenna apparatus comprises at least one antenna and a ground conductor plate,
wherein the ground conductor plate is provided so as to be close to the metal component to be electromagnetically coupled to the metal component, and so as to oppose the metal component, and
wherein the ground conductor plate has at least one opening.

6. The electronic apparatus according to claim 5,
wherein the electronic apparatus further comprises a display apparatus, and the metal component is a part of the display apparatus.
